(19) United States
(12) Patent Application Publication
(10) Pub. No.: US 2026/0359261 A1
(43) Pub. Date: Nov. 12, 2026

(54) SYSTEM AND METHOD FOR RETAINING AND DESTROYING ELECTRONIC DOCUMENTS

(71) Applicant: JPMorgan Chase Bank, N.A., New York, NY (US)

(72) Inventors: Nivas SHANKAR, Randolph, NJ (US); Naveen JADAYAMPALAYAM DHEVENDRAN, North Brunswick, NJ (US); Hemathri BALAKRISHNAN, Frisco, TX (US); Rama Krishna MADDIPATI, Glen Mills, PA (US); Ram GUTTA, Newark, DE (US); Matthew AGOSTINELLI, Plano, TX (US); Assaf MENTZER, Fair Lawn, NJ (US); Nilabh SHEKHAR, Hyderabad (IN); Shirsendu BASU, Chadds Ford, PA (US); Sundhu Sree GANNE, Celina, TX (US); Rodel CARRIDO, Cranbury, NJ (US); Karthick Praveen Kumar APPADURAI BASKARAN, Montville, NJ (US); Dhananjoy SARANGI, Hyderabad (IN); Ashley YUREK, Columbus, OH (US); Stephen M PAUL, Dublin, NJ (US); Aditya PATEL, Frisco, TX (US); Kaiwan MIRZA, North Arlington, NJ (US)

(73) Assignee: JPMorgan Chase Bank, N.A., New York, NY (US)

(21) Appl. No.: 19/261,745

(22) Filed: Jul. 7, 2025

(30) Foreign Application Priority Data
May 7, 2025 (IN) 202511044264

(51) Int. Cl. G06F 16/11; G06F 16/93

(52) U.S. Cl. CPC G06F 16/125; G06F 16/93

(57) ABSTRACT

Various aspects herein relate to retaining and destroying documents. The methodology includes: receiving a document designated for future destruction, the document including metadata and data; adding a specific retention and destruction policy to the metadata of the document; first identifying, in the metadata of the document, a segment of the document to be destroyed per the specific retention and destruction policy; confirming, from the data of the document, that the segment identified by the metadata exists in the document; storing the document for a period of time consistent with the specific retention and destruction policy; and destroying, in response to meeting of predetermined conditions as set forth in the specific retention and destruction policy, the segment of the document.

### CROSS REFERENCE TO RELATED APPLICATIONS

The instant application claims priority to India Patent Application Serial No. 202511044264 entitled SYSTEM and METHOD for RETAINING AND DESTROYING ELECTRONIC DOCUMENTS, filed May 7, 2025, the contents of which are expressly incorporated by reference in its entirety.

### TECHNICAL FIELD

This disclosure relates to methods and apparatuses for using an artificial intelligence/machine learning (AI/ML) model to perform retention and destruction of electronic documents in an accurate and efficient manner.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Many companies utilize various document retention and destruction methodologies to maintain their library of internal documents. Traditional retention and destruction methodologies encounter problems with ensuring that data is stored securely, retained for the appropriate duration, and destroyed in compliance with regulatory standards, all while maintaining cost-efficiency and enhancing the user experience. There are challenges in the complexities of metadata lifecycle management, regulatory compliance, and secure data destruction, which are critical for safeguarding data integrity and accessibility.

Traditional methodologies for document destruction present several technical problems. There is an unacceptably high risk that documents will be destroyed prematurely and/or inaccurately. To mitigate the risk, documents can be stored longer than necessary under less stringent destruction conditions, which consumes an excessive amount of computer storage. It also requires additional computer resources, electrical power and cost to manage outdated or unnecessary documents.

### SUMMARY

The present disclosure, through one or more of its various aspects, embodiments, and/or specific features or sub-components, provides, among other features, various systems, servers, devices, methods, media, programs, and platforms for using an AI/ML model to perform retention and destruction of electronic documents in an accurate and efficient manner.

According to an aspect of the present disclosure, a method is provided. The method includes: receiving a document designated for future destruction, the document including metadata and data; adding a specific retention and destruction policy to the metadata of the document; first identifying, in the metadata of the document, a segment of the document to be destroyed per the specific retention and destruction policy; confirming, from the data of the document, that the segment identified by the metadata exists in the document; storing the document for a period of time consistent with the specific retention and destruction policy; and destroying, in response to meeting of predetermined conditions as set forth in the specific retention and destruction policy, the segment of the document.

The above aspect may have various optional features. The destroying may not destroy portions of the document other than the segment, such that a remainder of the document remains in storage for a period of time as dictated by the specific retention and destruction policy. The method may include: repairing, in response to failure of the confirming, the metadata of the document to allow for future destruction of the segment; and returning to the confirming after the repairing. The adding may include: second identifying, within the metadata, a code that corresponds to a retention policy for the document; converting the code into a specific document retention policy; and incorporating the specific document retention policy into the metadata of the document as at least part of the specific retention and destruction policy. The segment may be a portion of the document, and the portion is a partition, row, column, or custom tagged area of the document. The destroying may destroy the metadata corresponding to the segment. The segment may include first and second segments, and the specific retention and destruction policy establishes different document retention policies for the first and second segments.

According to another aspect of the present disclosure, a system is provided. The system includes a processor, and a non-transitory computer readable memory storing instructions programmed to cooperate with the processor to cause the processor to perform operations. The operations include: receiving a document designated for future destruction, the document including metadata and data; adding a specific retention and destruction policy to the metadata of the document; first identifying, in the metadata of the document, a segment of the document to be destroyed per the specific retention and destruction policy; confirming, from the data of the document, that the segment identified by the metadata exists in the document; storing the document for a period of time consistent with the specific retention and destruction policy; and destroying, in response to meeting of predetermined conditions as set forth in the specific retention and destruction policy, the segment of the document.

The above aspect may have various optional features. The destroying may not destroy portions of the document other than the segment, such that a remainder of the document remains in storage for a period of time as dictated by the specific retention and destruction policy. The operations may include: repairing, in response to failure of the confirming, the metadata of the document to allow for future destruction of the segment; and returning to the confirming after the repairing. The adding may include: second identifying, within the metadata, a code that corresponds to a retention policy for the document; converting the code into a specific document retention policy; and incorporating the specific document retention policy into the metadata of the document as at least part of the specific retention and destruction policy. The segment may be a portion of the document, and the portion is a partition, row, column, or custom tagged area of the document. The destroying may destroy the metadata corresponding to the segment. The segment may include first and second segments, and the specific retention and destruction policy establishes different document retention policies for the first and second segments.

According to another aspect of the present disclosure, a non-transitory computer readable media storing instructions programmed to cooperate with a processor to cause the processor to perform operations is provided. The operations include: receiving a document designated for future destruction, the document including metadata and data; adding a specific retention and destruction policy to the metadata of the document; first identifying, in the metadata of the document, a segment of the document to be destroyed per the specific retention and destruction policy; confirming, from the data of the document, that the segment identified by the metadata exists in the document; storing the document for a period of time consistent with the specific retention and destruction policy; and destroying, in response to meeting of predetermined conditions as set forth in the specific retention and destruction policy, the segment of the document.

The above aspect may have various optional features. The destroying may not destroy portions of the document other than the segment, such that a remainder of the document remains in storage for a period of time as dictated by the specific retention and destruction policy. The operations may include: repairing, in response to failure of the confirming, the metadata of the document to allow for future destruction of the segment; and returning to the confirming after the repairing. The adding may include: second identifying, within the metadata, a code that corresponds to a retention policy for the document; converting the code into a specific document retention policy; and incorporating the specific document retention policy into the metadata of the document as at least part of the specific retention and destruction policy. The segment may be a portion of the document, and the portion is a partition, row, column, or custom tagged area of the document. The destroying may destroy the metadata corresponding to the segment. The segment may include first and second segments, and the specific retention and destruction policy establishes different document retention policies for the first and second segments.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIG. 4 illustrates an exemplary flow chart of a process for using an AI/ML model to perform retention and destruction of electronic documents in an accurate and efficient manner, in accordance with an embodiment.

FIG. 5 illustrates a model design that corresponds to a process for using an AI/ML model to perform retention and destruction of electronic documents in an accurate and efficient manner, in accordance with an embodiment.

FIGS. 6A-C illustrates a data flow that corresponds to a process for using an AI/ML model to perform retention and destruction of electronic documents in an accurate and efficient manner, in accordance with an embodiment.

Referring now to FIG. 7, an architecture for a Data Archival Retention Control (DARC) implementation is shown.

Referring now to FIG. 8, an architecture for CCB Data Governance is shown.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Traditional methodologies for document destruction present several technical problems. There is an unacceptably high risk that documents will be destroyed prematurely and/or inaccurately. To mitigate the risk, documents can be stored longer than necessary under less stringent destruction conditions, which consumes an excessive amount of computer storage. It also requires additional computer resources, electrical power and cost to manage outdated or unnecessary documents.

According to an aspect of the present disclosure, a method is provided. The method includes: receiving a document designated for future destruction, the document including metadata and data; adding a specific retention and destruction policy to the metadata of the document; first identifying, in the metadata of the document, a segment of the document to be destroyed per the specific retention and destruction policy; confirming, from the data of the document, that the segment identified by the metadata exists in the document; storing the document for a period of time consistent with the specific retention and destruction policy; and destroying, in response to meeting of predetermined conditions as set forth in the specific retention and destruction policy, the segment of the document.

The above aspect may have various optional features. The destroying may not destroy portions of the document other than the segment, such that a remainder of the document remains in storage for a period of time as dictated by the specific retention and destruction policy. The method may include: repairing, in response to failure of the confirming, the metadata of the document to allow for future destruction of the segment; and returning to the confirming after the repairing. The adding may include: second identifying, within the metadata, a code that corresponds to a retention policy for the document; converting the code into a specific document retention policy; and incorporating the specific document retention policy into the metadata of the document as at least part of the specific retention and destruction policy. The segment may be a portion of the document, and the portion is a partition, row, column, or custom tagged area of the document. The destroying may destroy the metadata corresponding to the segment. The segment may include first and second segments, and the specific retention and destruction policy establishes different document retention policies for the first and second segments.

The above implementations provide a technical solution to the technical problems of the traditional methods. Cross referencing the meta data with the data to confirm that segments designated for destruction actually exist in the document lowers the risk that documents will be destroyed prematurely and/or inaccurately. Documents can be stored for less time under more stringent destruction conditions, which consumes far less computer storage than traditional methods. There is also a corresponding storage reduction of in outdated or unnecessary documents, results in savings in computer resources, electrical power and management costs.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected.

“First,” “second,” etc., re labels to distinguish components or blocks of otherwise similar names, but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A. and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

A “retention and destruction policy” or the like establishes the condition(s) under which a record (document, data, etc.) is to be retained and then disposed of. A non-limiting example of a retention and destruction policy is to retain a tax record for seven years and then destroy it.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

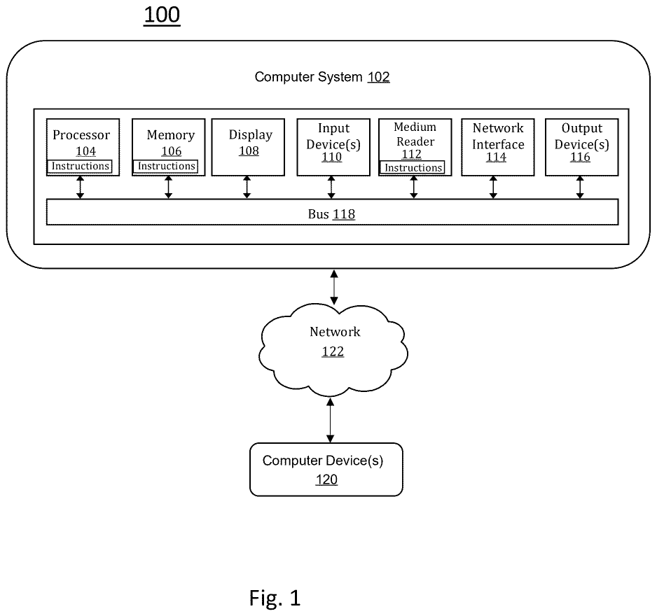

FIG. 1 is an exemplary system 100 for use in implementing a method for using an AI/ML model to retention and destruction of electronic documents in an accurate and efficient manner, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain't Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

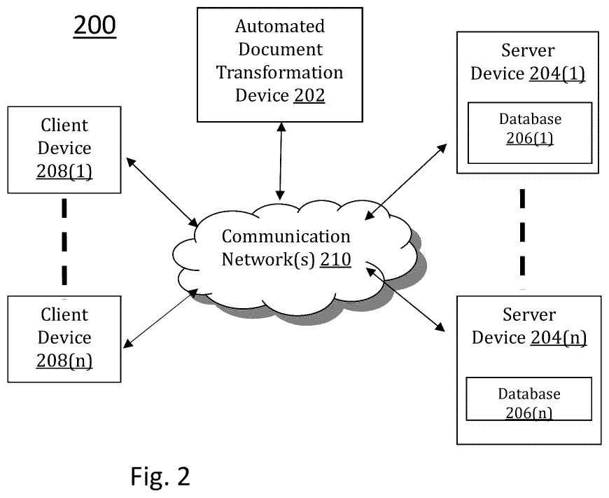

Referring to FIG. 2, a schematic of an exemplary network environment 200 for implementing a retention and destruction of electronic documents device (RDEDD) of the instant disclosure is illustrated. retention and destruction of electronic documents in an accurate and efficient manner

In some embodiments, the above-described problems associated with conventional tools may be overcome by implementing an RDEDD 202 as illustrated in FIG. 2 that may be configured for implementing a method for using an AI/ML model to perform retention and destruction of electronic documents in an accurate and efficient manner that is continually improvable by providing ongoing training to the AI/ML model/a semantic search approach, but the disclosure is not limited thereto.

The RDEDD 202 may have one or more computer system 102s, as described with respect to FIG. 1, which in aggregate provide the necessary functions.

The RDEDD 202 may store one or more applications that can include executable instructions that, when executed by the RDEDD 202, cause the RDEDD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RDEDD 202 itself, may be located in virtual server(s) running in a cloud-based computing environment rather than being tied to one or more specific physical network computing devices. Also, the application(s) may be running in one or more virtual machines (VMs) executing on the RDEDD 202. Additionally, in one or more embodiments of this technology, virtual machine(s) running on the RDEDD 202 may be managed or supervised by a hypervisor.

In the network environment 200 of FIG. 2, the RDEDD 202 is coupled to a plurality of server devices 204(1)-204(n) that hosts a plurality of databases 206(1)-206(n), and also to a plurality of client devices 208(1)-208(n) via communication network(s) 210. A communication interface of the RDEDD 202, such as the network interface 114 of the computer system 102 of FIG. 1, operatively couples and communicates between the RDEDD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RDEDD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RDEDD 202 may be a standalone device or integrated with one or more other devices or apparatuses, such as one or more of the server devices 204(1)-204(n), for example. In one particular example, the RDEDD 202 may be hosted by one of the server devices 204(1)-204(n), and other arrangements are also possible. Moreover, one or more of the devices of the RDEDD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the RDEDD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the RDEDD 202 that may efficiently provide a platform for implementing a method for using an AI/ML model to perform retention and destruction of electronic documents in an accurate and efficient manner, but the disclosure is not limited thereto.

The client devices 208(1)-208(n) may run interface applications, such as standard web browsers or standalone client applications, which may provide an interface to communicate with the RDEDD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the RDEDD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the RDEDD 202, the server devices 204(1)-204(n), or the client devices 208(1)-208(n), for example, may be configured to operate as virtual instances on the same physical machine. For example, one or more of the RDEDD 202, the server devices 204(1)-204(n), or the client devices 208(1)-208(n) may operate on the same physical device rather than as separate devices communicating through communication network(s) 210. Additionally, there may be more or fewer RDEDDs 202, server devices 204(1)-204(n), or client devices 208(1)-208(n) than illustrated in FIG. 2. In some embodiments, the RDEDD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

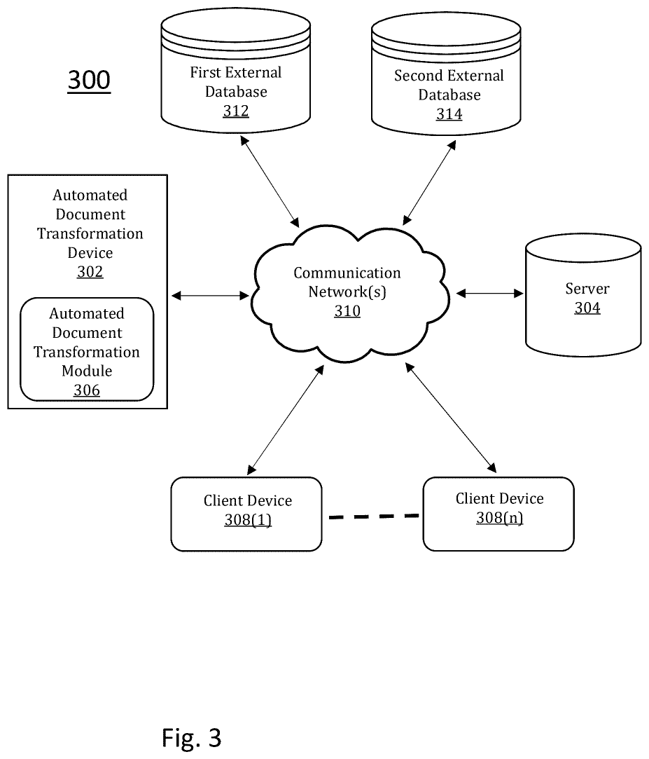

FIG. 3 illustrates a system diagram for implementing an RDEDD 302 having a retention and destruction of electronic documents module (RDEDM), in accordance with an embodiment.

As illustrated in FIG. 3, the system 300 may include an RDEDD 302 within which an RDEDM 306 is embedded, a server 304, a first external database 312, a second external database 314, a plurality of client devices 308(1) . . . 308(n), and a communication network 310.

In some embodiments, the RDEDD 302 including the RDEDM 306 may be connected to the server 304, and the database(s) 312 via the communication network 310. The RDEDD 302 may also be connected to the plurality of client devices 308(1) . . . 308(n) via the communication network 310, but the disclosure is not limited thereto.

In an embodiment, the RDEDD 302 is described and shown in FIG. 3 as including the RDEDM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the RDEDM 306 may be configured to receive real-time feed of data from the plurality of client devices 308(1) . . . 308(n) and secondary sources via the communication network 310.

The plurality of client devices 308(1) . . . 308(n) are illustrated as being in communication with the RDEDD 302. In this regard, the plurality of client devices 308(1) . . . 308(n) may be “clients” (e.g., customers) of the RDEDD 302 and are described herein as such. Nevertheless, it is to be known and understood that the plurality of client devices 308(1) . . . 308(n) need not necessarily be “clients” of the RDEDD 302, or any entity described in association therewith herein. Any additional or alternative relationship may exist between either or both of the plurality of client devices 308(1) . . . 308(n) and the RDEDD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the RDEDD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The RDEDD 302 may be the same or similar to the RDEDD 202 as described with respect to FIG. 2, including any features or combination of features described with respect thereto.

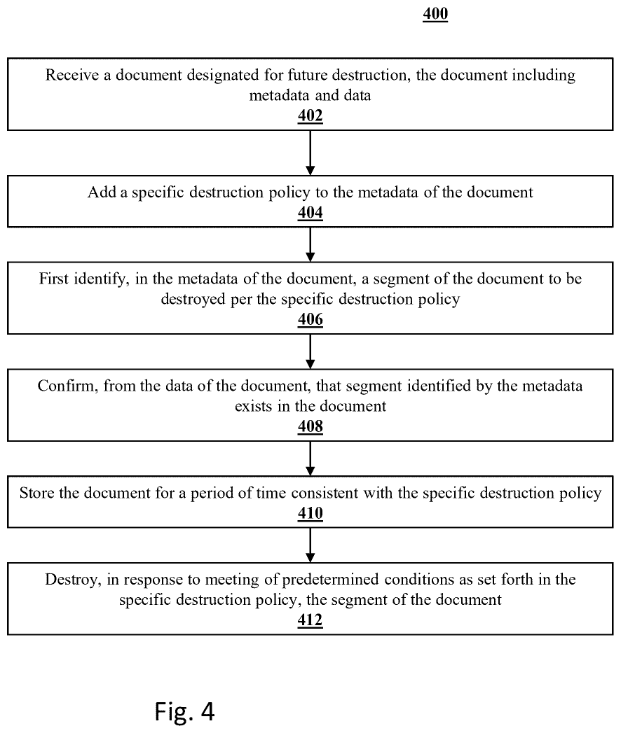

FIG. 4 illustrates an exemplary flow chart of a process 400 implemented by the RDEDM 306 of FIG. 3 for enablement of a system and a method for using an AI/ML model to perform retention and destruction of electronic documents in an accurate and efficient manner, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step 402, the process 400 may include receiving a document designated for future destruction, the document including metadata and data.

At step 404, the process 400 may include adding a specific retention and destruction policy to the metadata of the document.

At step 406, the process may include first identifying, in the metadata of the document, a segment of the document to be destroyed per the specific retention and destruction policy.

At step 408, the process 400 may include confirming, from the data of the document, that the segment identified by the metadata exists in the document.

At step 410, the process 400 may include storing the document for a period of time consistent with the specific retention and destruction policy.

At step 412, the process 400 may include destroying, in response to meeting of predetermined conditions as set forth in the specific retention and destruction policy, the segment of the document.

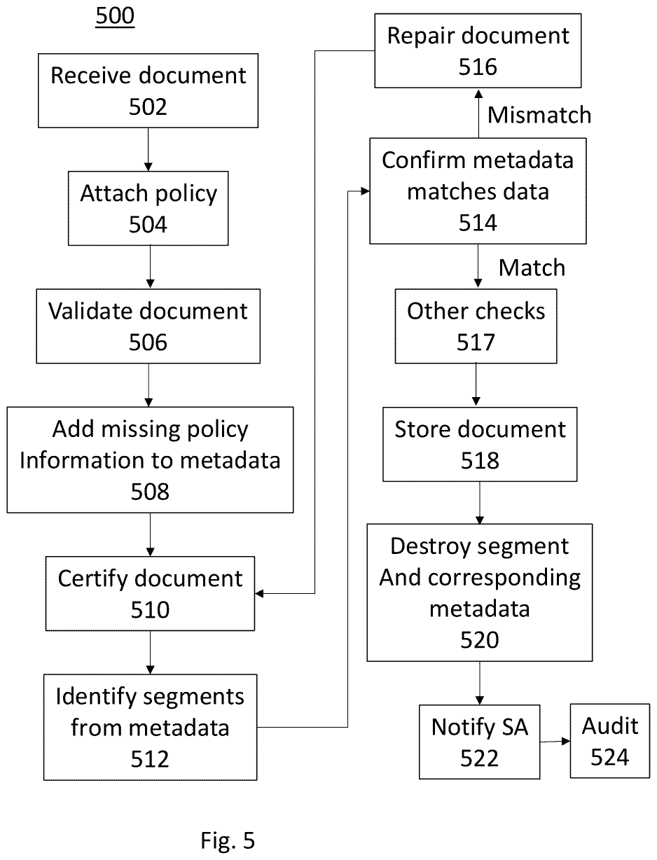

Referring now to FIG. 5, a process 500 is shown to prepare a document for destruction. At step 502, the document designed for at least partial destruction is received. The document includes a metadata portion and a distinct data portion. The document may be any document in electronic format, and the invention is not limited to any type of document or format.

At step 504, exception type specific retention/destruction policies may be attached to the document in the metadata regarding its retention and destruction. These are policies that would supersede any later added retention/destruction policies that are specific to the document. By way of non-limiting example, a litigation hold requirement may dictate retention of the document in a manner distinct from normal company policies for the document until such time as the litigation hold is lifted.

At step 506, process 500 validates the document, confirming that the document is authentic, accurate, and complies with relevant legal, regulatory, and organizational requirements. The validation may ensure that the document does not contain, or a user has not entered for the document, any information outside of that required to process the document.

At step 508, process 500 identifies and adds to the document any missing retention and destruction policy information needed to implement the retention/destruction process. By way of non-limiting example, the document may have one or more associated Retention Class Codes (RCC) that corresponds to the specific retention policies for the document or a portion of the document. This step may convert the RCC into an actual policy that is incorporated into the metadata of the document. All retention/destruction policies as added to the metadata (at this step or elsewhere) collectively define the retention and destruction policy for the document.

At step 510, process 500 certifies that the document is ready for processing. This certification may be by a user via manual interaction, or by a trained AI/ML model.

At step 512, the methodology identifies from the metadata which segments of the document are to be destroyed, and under what conditions. Segments may be a portion of the document, including but not limited to partitions, rows, columns, or custom tagged areas. A document may have different segments for destruction, and each segment may have its own retention/destruction conditions. A segment may also be the entire document.

Retention/destruction conditions generally refer to the conditions upon which a segment of a retained document is to be destroyed. Non-limiting examples of conditions include time conditions, rule conditions, and/or custom conditions. An example of time condition could be to destroy row X of the document three years after the document was created. An example of a rule condition could be a litigation hold requirement was removed. The invention is not limited to the specific conditions that dictate when retained documents are to be destroyed. Exception type conditions as added at step 504 may supersede other conflicting conditions as set forth in the metadata.

At step 514, process 500 examines the data of the document to confirm that the segments identified by the metadata for the document exist in the actual data of the document. A mismatch occurs, for example, when the metadata identifies a segment but the segment is not present in the actual document per the data. By way of non-limiting example, if step 512 identified from the metadata destroy row X of the document three years after the document was created and step 514 determines that row X does not exist in the document per the data, then a mismatch exists between the metadata and the data of the document.

In response to a mismatch, at step 516 the destruction protocol is suspended for the document, and the document is sent for repair to a user and/or an AI/ML model to identify and correct the problem. A repaired document can renter the process 500 at an appropriate point, such as step 510.

In response to a match, at step 517 the process will implement second checks. One such second check is to identify, within accessible storage, duplicates of the original data that is scheduled for destruction. The retention and destruction policy will be added to the duplicative data, such that the duplicates will be preserved and destroyed on the same schedule as the original data.

Another second check is for interdependent data which, while not duplicative to the original data for destruction, is closely related enough that the interdependent data should be preserved and destroyed on the same schedule as the original data. As interdependent data may be a judgment call, the interdependency can be flagged for further supervisory authority and/or AI model review before the retention and destruction policy is applied thereto.

Another second check is for the presence of anti-patterns in the original data that indicates to the model that, notwithstanding the retention and destruction policy assigned to the original data, something about the original data suggests that it should not be destroyed (at least not on the timetable of the assigned retention and destruction policy). The model may consider anti-patterns in factors such as table, column, structure, location, format and partition. As the impact of anti-patterns may be a judgment call, the interdependency can be flagged for further supervisory authority and/or AI model review before the retention and destruction policy is applied thereto

At step 518 the document is retained in appropriate storage until such time as its full or partial destruction is called for by the retention and destruction policy.

At step 520, the conditions are met for the destruction of the segment, and the segment is so destroyed, along with any metadata corresponding to that segment. All backup copies may also be destroyed. Index entries and/or catalog entries identifying the document and/or the segment may also be destroyed as appropriate.

After destruction, at step 522, the supervisory authority is notified of the destruction.

At step 524, an audit is performed to confirm that the destruction is consistent with the expectations per step 510. The results are collected in an evidence collector at step 526 for further reference and analysis as may be desired.

An AI model powered compliance monitoring and reporting module may be monitoring the above tasks and provide feedback to a supervisory authority. The module may scan regulatory standard documents in real-time and compare it with the current policies in the systems. Dynamic retention policies can be updated and alerted to the supervisory authority.

The AI model can also provide metric predictions that analyze historical data usage and retention patterns to provide actionable insights for future data management strategies. By forecasting trends, the system optimizes storage costs, improving data accessibility and enhancing overall operational efficiency. By way of non-limiting example, the module can predict how much space was saved, how much data will be deleted, and how many people will lose access to the data.

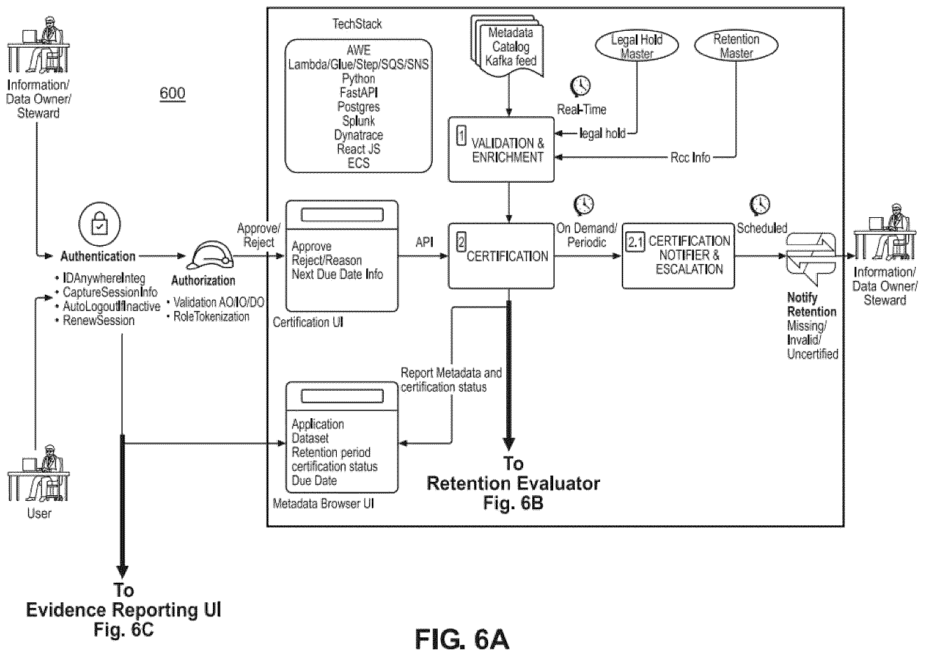

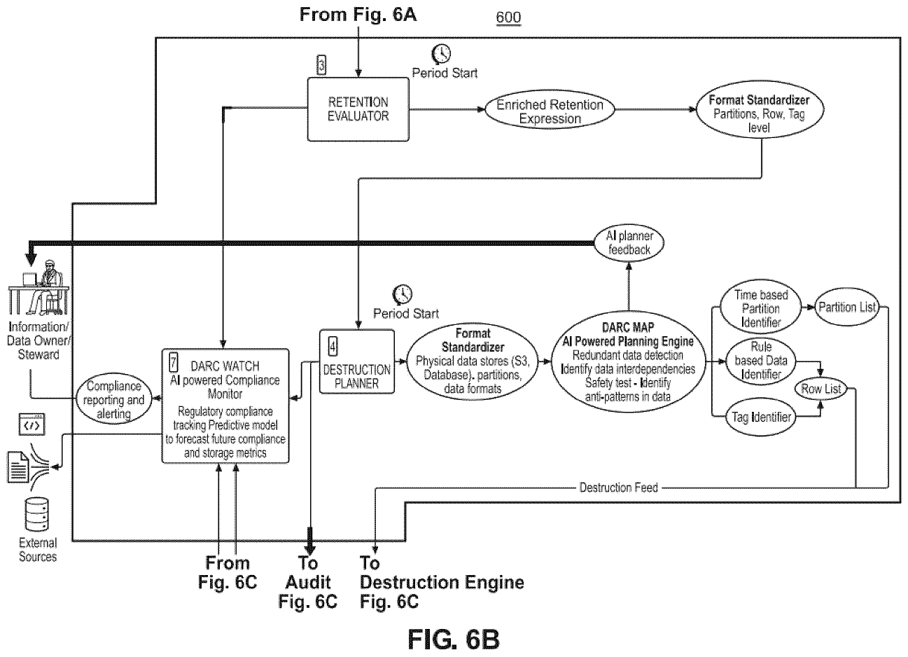

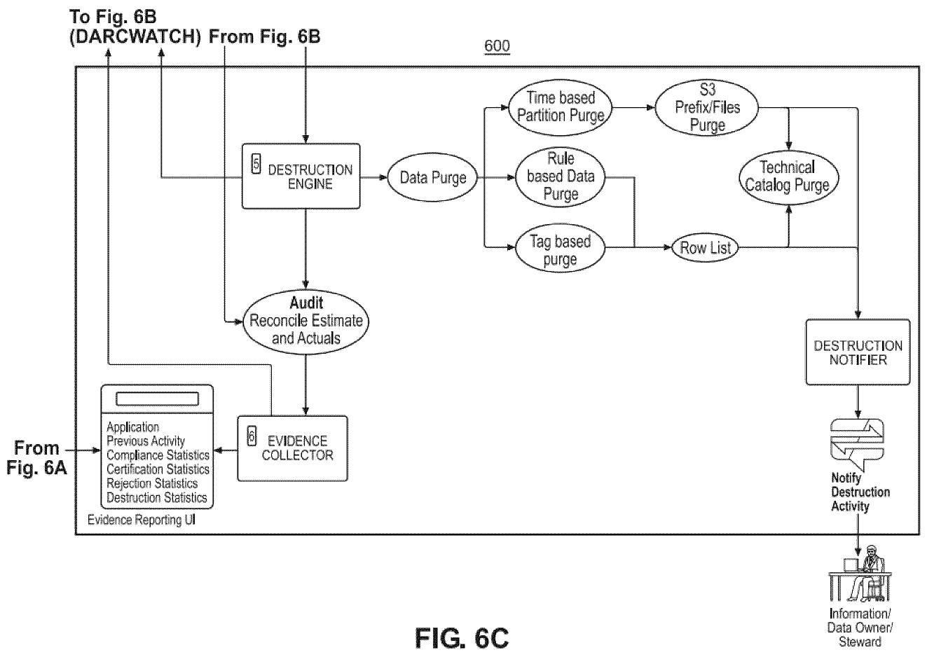

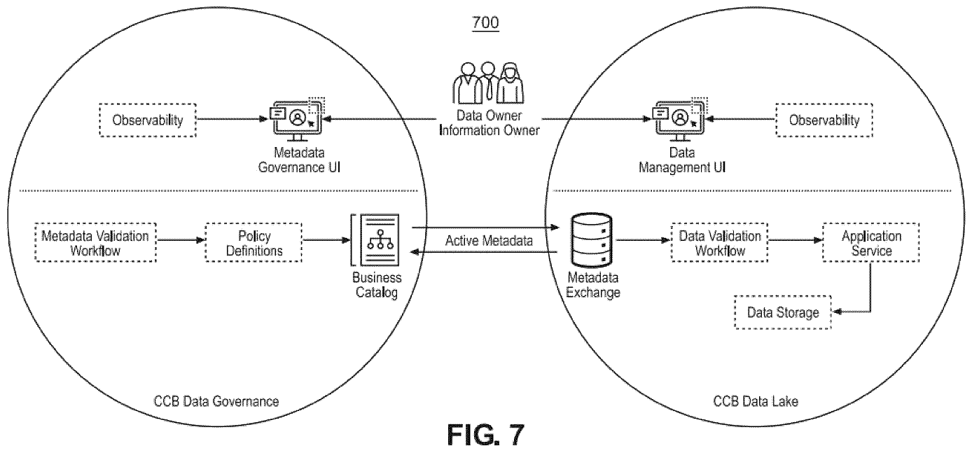

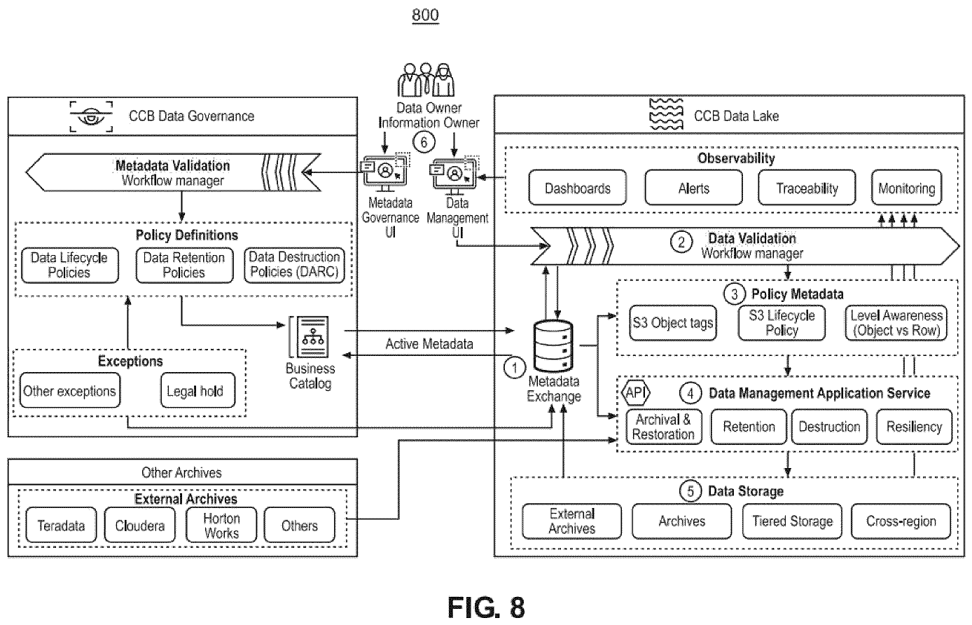

FIGS. 6A-6C show a data flow 600 of an aspect of the present disclosure.

The above implementations provide a technical solution to the technical solutions of the traditional methods. Cross referencing the meta data with the data to confirm that segments designated for destruction actually exist in the document lowers the risk that documents will be destroyed prematurely and/or inaccurately. Documents can be stored for less time under more stringent destruction conditions, which consumes far less computer storage than traditional methods. There is also a corresponding storage reduction of in outdated or unnecessary documents, results in savings in computer resources, electrical power and management costs.

Referring now to FIG. 7, an architecture for a Data Archival Retention Control (DARC) implementation of the methodologies with CCB Data Lake is shown. The implementation provides a comprehensive, resilient, secure, and compliant data lake aligned to a company's requirements. The implementation enables business with data management capabilities using redundant storage, strong failover mechanisms, automating long-term data archival and retention that meets regulatory compliance, enforcing secure and auditable data destruction mechanisms, ensuring cost-efficiency using cloud-native storage optimization features and enhancing the user experience by providing an end-to-end CCB Data Governance observability. The methodologies evolve around the metadata lifecycle enabled by the CCB Data Governance environment and data lifecycle enforced by the CCB Data Lake platform. Active metadata exchange occurs between the environments, facilitating streamlined data management operations delivering an efficient and real-time user experience.

Referring now to FIG. 8, and architecture 800 is shown. The CCB Data Governance provides a metadata governance user interface (UI) enabling Data Owners and Information owners to submit metadata for data management tasks such as archival, retention, and destruction based on the business and regulatory requirements. This includes specifying details like Retention Class Code (RCC), the country of customer, and applicable filters for data inclusion and/or exclusion. The provided metadata undergoes real-time validation within the Governance validation workflow confirming the accuracy and integrity for downstream processes. Adherence to master data systems, legal holds and other regulatory exceptions are validated and feedback is provided back to the users. The resulting unified data management policy definitions are stored in the business catalog and published to the downstream systems. Regular certification process of data management policies by the user is part of the governance process, safeguarding against unauthorized data destruction.

The DARC implementation enables “Active Metadata” to continuously access the centralized CCMS Data catalog and process metadata in the Data Lake platform by becoming action-oriented and making it easier for the Data Owner to act intelligently on DARC requirements. The DARC requirements can process metadata based on business metadata, technical metadata, data archival conditions, retention class code and destruction policies. The DARC metadata provides comprehensive operational information of workflow processing details, application service configurations and the latest snapshot of dataset states within the data lake. This centralized repository has the capability to circulate any retained information back into the CCMS Data catalog or to any other cross product services, thereby maintaining a consistent and single source of truth information.

The data management workflow manager enforces DARC requirements by maintaining the latest snapshot of the dataset state, which confirms with the active metadata principle. Discrepancies of dataset level information and enforcement details can be reported back to the data owner and information owner through the data management user interface. This user interface also provides stakeholders such as governance, Data Owner, Application Owner, Information Owner, and security team with a comprehensive view of data slated for archival or destruction, empowering them to make informed decisions. Mechanisms for escalating unverified workflows and the status of the workflows are displayed to the stakeholders for full transparency.

A policy enforcement orchestrator serves as the brain for the CCB data lake's data management environment, transforming data management metadata into cloud-native technical specifications. It understands an array of cloud-native features necessary for data management tasks such as S3 Object tagging, lifecycle policies, resilient data stores, and the policies that need row level data destruction (as required by GDPR or CCPA). This also performs orchestrations through scheduled or intelligent event-driven mechanisms and invokes the application microservices for executing data management tasks in data lake platform.

The application service may adhere to stateless, decoupled architecture principles, ensuring all data management operations are performed efficiently. While every component can operate independently, they can leverage the centralized active metadata repository to maintain synergy. The microservices are designed to gracefully scale horizontally to meet the future data management needs. Additionally, every service can capture audits, logs, and traces, which help to improve operational efficiency, control costs, and enable comprehensive monitoring of the platform. This design guarantees secure data destruction with accountability and evidence to ensure no data can be reconstructed. The application microservices are provisioned as microservices to enable external teams to effectively use the data lake and all the associated data management features.

This solution enables CCB Data Lake to adopt a cloud-native data storage solution that provides intelligent tiered solutions and inherent cross-region resiliency, ensuring dataset lifecycle policies determined by the nature of the data, usage frequency, data usage and consumer access patterns as determined by the users. The storage solution expands support beyond simple storage to additional open table formats, multimedia data types, and operational stores that enforce data archival and retention process. Stakeholder teams are empowered to leverage DARC services of the data lake.

An objective is to deliver a seamless user experience to data owners, information owners and stakeholders by providing them easier decision-making process for managing DARC and Data Lake compliance enforcements. Users receive real-time feedback from validation workflows for both data and metadata management processes. User Interface provides a preview of actionable data so users can confidently confirm data management decisions. Actions or escalations requiring attention are made identifiable in the UI to allow quick actions. Comprehensive evidence and traceability for all data management actions, supported by performance dashboards, provide insights needed to make informed decisions.

Data Management of the above methodologies may be subject to the following guiding principles.

Resiliency and Disaster Recovery: Implement redundant storage solutions and application failover mechanisms to guarantee high availability in the event of system failures. Develop automated and regular backup of data and associated metadata across cloud regions to facilitate disaster recovery.

Archival and Retention: Provide scalable archival solutions for a long-term data storage that are cost-effective while ensuring data accessibility. Automate the retention of data accordance to the business and regulatory requirements, ensuring data is retained for the appropriate duration before deletion.

Data Destruction: Implement mechanisms for secure and verifiable deletion of the data that align with compliance requirements, ensuring that data cannot be reconstructed or retrieved post-deletion anywhere from storage. Automate the purging of the data that is beyond its retention period, based on predefined policies, to manage data destruction costs and minimize compliance risks.

Security and Compliance: Data at rest and in transit can be encrypted or tokenized to protect against unauthorized access. Implement fine-grain access controls and authentication mechanisms to ensure that only authorize users can access sensitive data. Regularly ensure that the data management practices are meeting the evolving regulatory requirements including GPDR, CCPA and others.

Cost Management: Monitor and optimize data storage utilization to balance performance needs with cost savings. Conduct cost-benefit analysis to ensure the data management strategies meet the business objectives efficiently.

Agility and Scalability: Design the data management platform to easily scale up based on the data changes without compromising performance. Enable scaling of the application compute independent of the data storage.

User experience and Observability: Provide real-time monitoring tools to track data usage, performance metrics and system health to promptly identify and address issues. Maintain comprehensive logs and audit trails for all data management activities to support security and compliance investigations.

In some embodiments as disclosed above in FIGS. 1-8, technical improvements effected by the instant disclosure may include a platform for implementing an to perform retention and destruction of electronic documents in an accurate and efficient manner, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving a document designated for future destruction, the document including metadata and data;
adding a specific retention and destruction policy to the metadata of the document;
first identifying, in the metadata of the document, a segment of the document to be destroyed per the specific retention and destruction policy;
confirming, from the data of the document, that the segment identified by the metadata exists in the document;
storing the document for a period of time consistent with the specific retention and destruction policy; and
destroying, in response to meeting of predetermined conditions as set forth in the specific retention and destruction policy, the segment of the document.

2. The method of claim 1, wherein the destroying does not destroy portions of the document other than the segment, such that a remainder of the document remains in storage for a period of time as dictated by the specific retention and destruction policy.

3. The method of claim 1, further comprising:
repairing, in response to failure of the confirming, the metadata of the document to allow for future destruction of the segment; and
returning to the confirming after the repairing.

4. The method of claim 1, wherein the adding further comprises:
second identifying, within the metadata, a code that corresponds to a retention policy for the document;
converting the code into a specific document retention policy; and
incorporating the specific document retention policy into the metadata of the document as at least part of the specific retention and destruction policy.

5. The method of claim 1, wherein the segment is a portion of the document, and the portion is a partition, row, column, or custom tagged area of the document.

6. The method of claim 1, wherein the destroying destroys the metadata corresponding to the segment.

7. The method of claim 1, wherein the segment comprises first and second segments, and the specific retention and destruction policy establishes different document retention policies for the first and second segments.

8. A system comprising:
a processor;
a non-transitory computer readable memory storing instructions programmed to cooperate with the processor to cause the processor to perform operations comprising:
receiving a document designated for future destruction, the document including metadata and data;
adding a specific retention and destruction policy to the metadata of the document;
first identifying, in the metadata of the document, a segment of the document to be destroyed per the specific retention and destruction policy;
confirming, from the data of the document, that the segment identified by the metadata exists in the document;
storing the document for a period of time consistent with the specific retention and destruction policy; and
destroying, in response to meeting of predetermined conditions as set forth in the specific retention and destruction policy, the segment of the document.

9. The system of claim 8, wherein the destroying does not destroy portions of the document other than the segment, such that a remainder of the document remains in storage for a period of time as dictated by the specific retention and destruction policy.

10. The system of claim 8, the operations further comprising:
repairing, in response to failure of the confirming, the metadata of the document to allow for future destruction of the segment; and
returning to the confirming after the repairing.

11. The system of claim 8, wherein the adding further comprises:
second identifying, within the metadata, a code that corresponds to a retention policy for the document;
converting the code into a specific document retention policy; and
incorporating the specific document retention policy into the metadata of the document as at least part of the specific retention and destruction policy.

12. The system of claim 8, wherein the segment is a portion of the document, and the portion is a partition, row, column, or custom tagged area of the document.

13. The system of claim 8, wherein the destroying destroys the metadata corresponding to the segment.

14. The system of claim 8, wherein the segment comprises first and second segments, and the specific retention and destruction policy establishes different document retention policies for the first and second segments.

15. A non-transitory computer readable media storing instructions programmed to cooperate with a processor to cause the processor to perform operations comprising:
receiving a document designated for future destruction, the document including metadata and data;
adding a specific retention and destruction policy to the metadata of the document;
first identifying, in the metadata of the document, a segment of the document to be destroyed per the specific retention and destruction policy;
confirming, from the data of the document, that the segment identified by the metadata exists in the document;
storing the document for a period of time consistent with the specific retention and destruction policy; and
destroying, in response to meeting of predetermined conditions as set forth in the specific retention and destruction policy, the segment of the document.

16. The non-transitory computer readable media of claim 15, wherein the destroying does not destroy portions of the document other than the segment, such that a remainder of the document remains in storage for a period of time as dictated by the specific retention and destruction policy.

17. The non-transitory computer readable media of claim 15, the operations further comprising:
repairing, in response to failure of the confirming, the metadata of the document to allow for future destruction of the segment; and
returning to the confirming after the repairing.

18. The non-transitory computer readable media of claim 15, wherein the adding further comprises:
second identifying, within the metadata, a code that corresponds to a retention policy for the document;
converting the code into a specific document retention policy; and
incorporating the specific document retention policy into the metadata of the document as at least part of the specific retention and destruction policy.

19. The non-transitory computer readable media of claim 15, wherein the segment is a portion of the document, and the portion is a partition, row, column, or custom tagged area of the document.

20. The non-transitory computer readable media of claim 15, wherein the destroying destroys the metadata corresponding to the segment.
